(19) United States
(12) Patent Application Publication
(10) Pub. No.: US 2013/0306637 A1
(43) Pub. Date: Nov. 21, 2013

(54) Lid Lock For Garbage Bin Used In Automated Collection

(71) Applicant: Charles DelBert Pallwitz, Pleasant Hill, IA (US)

(72) Inventor: Charles DelBert Pallwitz, Pleasant Hill, IA (US)

(21) Appl. No.: 13/472,487

(22) Filed: May 16, 2012

(51) Int. Cl. B65D 45/00; B23P 19/04

(52) U.S. Cl. 220/315; 29/426.1

(57) ABSTRACT

Certain types of garbage bins that allow for automated garbage collection are becoming increasingly prevalent. These bins come with a hinged lid that will open when the garbage bin is lifted by mechanical arms. This invention discloses a lock that can be attached to the lid of the garbage bin that will keep the lid closed when the bin is standing upright but will automatically release when the bin is tilted at an angle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to bins used in automated garbage disposal, and specifically to a device that allows the lid of these bins to be locked in a closed position.

2. Description of Related Art

It is becoming increasingly common for garbage disposal services to issue particular garbage bins that are specially designed to allow arms on a garbage truck to lift and empty the garbage bin.

U.S. Pat. No. 3,618,814 to Nagroski discloses a weighted lid for a garbage bin that locks in a closed position with springs. U.S. Pat. No. 5,738,395 to Probst discloses a garbage bin that is used for automated garbage pickup with a self release lock. This relies on a latching member that engages with a keeper member to lock the lid in place. As seen by these patents, the prior art does not disclose a single member to lock the lid in place.

### SUMMARY OF THE INVENTION

The present invention provides an attachment to a garbage bin lid that will lock the lid in a closed position to prevent trash from falling out and animals from getting in. Also, if the lid stays closed, this makes it more difficult for the bin to tip over due to a large gust of wind. The attachment only requires two members, one member that directly attaches to the garbage bin lid and a second locking member that attaches to the first member. This second member can rotate which allows it to lock the lid in place when the bin is upright but will automatically disengage when the bin is tilted at an angle.

### BRIEF DESCRIPTION OF THE FIGURES

FIG. 1 is a perspective view of the lid lock attached to a garbage bin, along with an indication of how the lock will swing when engaged and disengaged.

FIG. 2 is a side view of the lock in both an engaged and disengaged position.

FIG. 3 is a top down view of the lock in both an engaged and disengaged position.

### DETAILED DESCRIPTION OF THE INVENTION

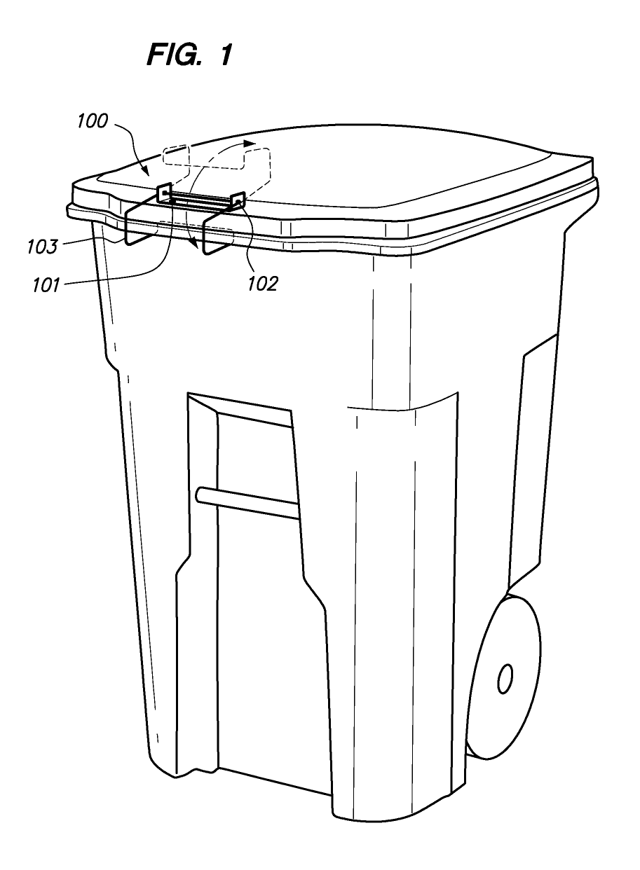

FIG. 1 shows the engaging member 100 attached to a preexisting garbage bin lid and also shows how the lid lock 103 will rotate based on the angle of the preexisting garbage bin. In the preferred embodiment, this engaging member 100 is made of a metal alloy such as spring steel or stainless steel. In an alternative embodiment, the engaging member 100 can be made of a hard plastic that can be injection molded into the garbage bin lid itself.

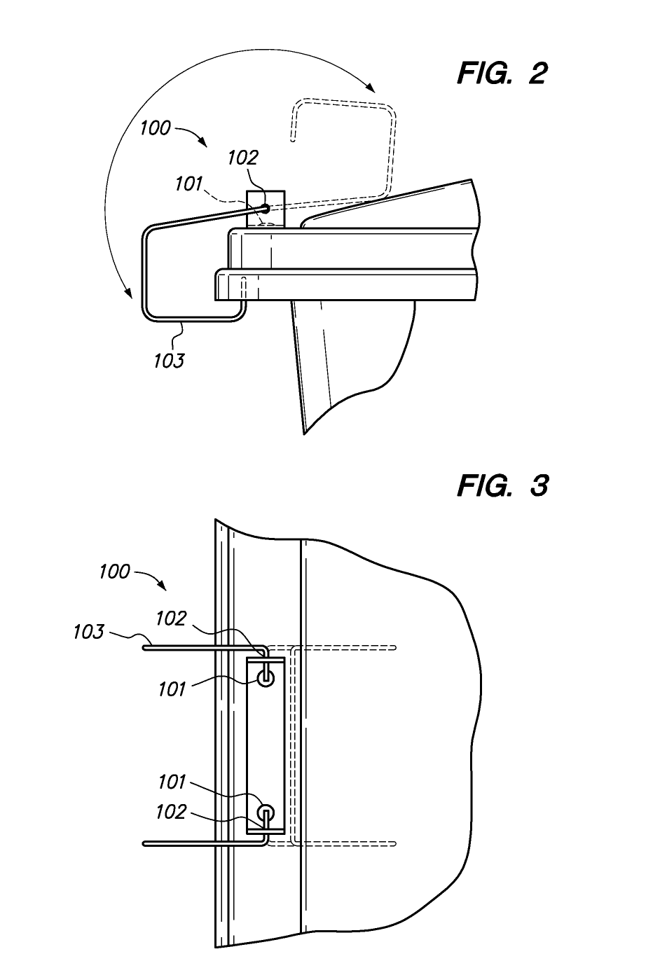

FIGS. 2 and 3 shows how the engaging member 100 can be attached to the preexisting garbage bin lid at two different points 101. In the preferred embodiment, the engaging member 100 is attached to the preexisting garbage bin lid using a nut and bolt assembly at the two points 101. In an alternative embodiment, the engaging member 100 can be attached to the preexisting garbage bin lid using a strong adhesive that covers the entire backside of the engaging member rather than at just two points.

The engaging member 100 has two protrusions 102 standing up at a 90 degree angle from the plane of the preexisting garbage bin lid. The lid lock 103 is connected to the engaging member 100 at the two protrusions 102. The protrusions 102 are a part of the engaging member 100 so they will be made of the same material as the engaging member 100. The protrusions 102 can be of a rectangular shape with a hole centered within the rectangle. The protrusions 102 can also have a rectangular base but rounded off corners to so there will be no sharp edges for someone attaching the lid lock 103. In the preferred embodiment, the lid lock is connected to the two protrusions by sliding a section of the lid lock 103 through the holes in the two protrusions 102. This makes for a secure engagement between the lid lock 103 and the engaging member 100, but also allows the lid lock 103 to be removed and replaced if necessary. In the preferred embodiment, the lid lock 103 is made of aluminum as aluminum can be bent but remain sturdy enough to maintain its shape. Other materials with properties similar to aluminum can also be used for the lid lock 103.

In the preferred embodiment, the lid lock 103 is bent at three different points to give it a rectangular shape that will allow it to rest flatly on the lid of the bin when the lid lock 103 is not engaged. In an alternative embodiment, the lid lock 103 can have a rounded shape without distinct folds, which will allow the same locking and automatic unlocking function. However, a lid lock 103 with a rounded shape will not rest flatly on the lid of the bin when not in use.

What is claimed is:

1. An attachment that locks a hinged garbage bin lid closed, then automatically releases when the garbage bin is raised during automated garbage pickup, comprising:
a preexisting garbage bin and a preexisting garbage bin lid;
wherein said preexisting garbage bin lid has a front end and a back end and said back end of said preexisting garbage bin lid is hingedly connected to a back end of said preexisting garbage bin;
wherein said preexisting garbage bin includes a front protrusion within a front end of said preexisting garbage bin;
an engaging member made of a sturdy material that is securely connected to said front end of said preexisting garbage bin lid;
a locking member made of a sturdy material and of a sufficient shape that is securely connected to said engaging member and will lock said preexisting garbage bin lid in a closed position when said locking member securely engages said front protrusion on said front end of said preexisting garbage bin when said preexisting garbage bin is set upright on a flat surface;
wherein said locking member will automatically disengage and allow said preexisting garbage bin lid to open when said preexisting garbage bin is raised and tilted at an angle.

2. The attachment of claim 1, wherein said sturdy material of said engaging member and said sturdy material of said locking member is a metal alloy.

3. The attachment of claim 2, wherein said engaging member has a left end and a right end and is connected to said preexisting garbage bin lid using a first nut and bolt assembly on said left end of said engaging member and a second nut and bolt assembly on said right end of said engaging member.

4. The attachment of claim 1, wherein said sturdy material of said engaging member is a hard plastic;
wherein said engaging member is connected to said preexisting garbage bin lid using injection molding so that said engaging member is embedded in said preexisting garbage bin lid itself.

5. The attachment of claim 3, wherein said metal alloy is spring steel.

6. The attachment of claim 3, wherein said metal alloy is stainless steel.

7. The attachment of claim 4, wherein said engaging member has a first upright protrusion of a sufficient height on said left end of said engaging member and a second upright protrusion of a sufficient height on said right end of said engaging member;
wherein said first upright protrusion has a first hole of a sufficient size that is centered within said first upright protrusion and said second upright protrusion has a second hole of a sufficient size that is centered within said second upright protrusion;
wherein said locking member has a right securing hook and a left securing hook;
wherein said right securing hook of said locking member is connected to said engaging member by sliding said right securing hook through said first hole of said engaging member and said left securing hook of said locking member is connected to said engaging member by sliding said left securing hook through said second hole of said engaging member.

8. The attachment of claim 5, wherein said engaging member has a first upright protrusion of a sufficient height on said left end of said engaging member and a second upright protrusion of a sufficient height on said right end of said engaging member;
wherein said first upright protrusion has a first hole of a sufficient size that is centered within said first upright protrusion and said second upright protrusion has a second hole of a sufficient size that is centered within said second upright protrusion;
wherein said locking member has a right securing hook and a left securing hook;
wherein said right securing hook of said locking member is connected to said engaging member by sliding said right securing hook through said first hole of said engaging member and said left securing hook of said locking member is connected to said engaging member by sliding said left securing hook through said second hole of said engaging member.

9. The attachment of claim 7, wherein said locking member comprises a single member with a right half and a left half,
wherein said right half has a first folded angle after a first sufficient length, a second folded angle after a second sufficient length and a third folded angle after a third sufficient length; after a first sufficient length, a second folded angle after a second sufficient length and a third folded angle after a third sufficient length;
wherein said left half has a first folded angle after a first sufficient length, a second folded angle after a second sufficient length and a third folded angle after a third sufficient length; after a first sufficient length, a second folded angle after a second sufficient length and a third folded angle after a third sufficient length;

10. The attachment of claim 8, wherein said locking member comprises a single member with a right half and a left half,
wherein said right half has a first folded angle after a first sufficient length, a second folded angle after a second sufficient length and a third folded angle after a third sufficient length; after a first sufficient length, a second folded angle after a second sufficient length and a third folded angle after a third sufficient length;
wherein said left half has a first folded angle after a first sufficient length, a second folded angle after a second sufficient length and a third folded angle after a third sufficient length; after a first sufficient length, a second folded angle after a second sufficient length and a third folded angle after a third sufficient length;

11. The attachment of claim 9, wherein said first folded angle, said second folded angle and said third folded angle of both said right half and said left half is 90 degrees.

12. The attachment of claim 9, wherein said first folded angle, said second folded angle and said third folded angle of both said right half and said left half is 90 degrees.

13. An attachment that locks a hinged garbage bin lid closed, then automatically releases when the garbage bin is raised during automated garbage pickup, comprising:
a preexisting garbage bin and a preexisting garbage bin lid;
wherein said preexisting garbage bin lid has a front end and a back end and said back end of said preexisting garbage bin lid is hingedly connected to a back end of said preexisting garbage bin;
wherein said preexisting garbage bin includes a front protrusion within a front end of said preexisting garbage bin;
an engaging member made of a sturdy material that is securely connected to said front end of said preexisting garbage bin lid;
a locking member made of a sturdy material and of a sufficient shape that is securely connected to said engaging member and will lock said preexisting garbage bin lid in a closed position when said locking member securely engages said front protrusion on said front end of said preexisting garbage bin when said preexisting garbage bin is set upright on a flat surface;
wherein said locking member will automatically disengage and allow said preexisting garbage bin lid to open when said preexisting garbage bin is raised and tilted at an angle;
wherein said locking member comprises a single member with a right half and a left half;
wherein said right half has a first folded angle after a first sufficient length, a second folded angle after a second sufficient length and a third folded angle after a third sufficient length; after a first sufficient length, a second folded angle after a second sufficient length and a third folded angle after a third sufficient length;
wherein said left half has a first folded angle after a first sufficient length, a second folded angle after a second sufficient length and a third folded angle after a third sufficient length; after a first sufficient length, a second folded angle after a second sufficient length and a third folded angle after a third sufficient length;
wherein said first sufficient length, said second sufficient length and said third sufficient length of said right half is approximately one third of the total length of said right half;
wherein said first sufficient length, said second sufficient length and said third sufficient length of said left half is approximately one third of the total length of said left half.

14. The attachment of claim 13, wherein said sturdy material of said engaging member and said sturdy material of said locking member is a metal alloy.

15. The attachment of claim 13, wherein said sturdy material of said engaging member is a hard plastic;
wherein said engaging member is connected to said preexisting garbage bin lid using injection molding so that said engaging member is embedded in said preexisting garbage bin lid itself.

16. The attachment of claim 14, wherein said metal alloy is spring steel.

17. The attachment of claim 14, wherein said metal alloy is stainless steel.

18. The attachment of claim 15, wherein said engaging member has a first upright protrusion of a sufficient height on said left end of said engaging member and a second upright protrusion of a sufficient height on said right end of said engaging member;
wherein said first upright protrusion has a first hole of a sufficient size that is centered within said first upright protrusion and said second upright protrusion has a second hole of a sufficient size that is centered within said second upright protrusion;
wherein said locking member has a right securing hook and a left securing hook;
wherein said right securing hook of said locking member is connected to said engaging member by sliding said right securing hook through said first hole of said engaging member and said left securing hook of said locking member is connected to said engaging member by sliding said left securing hook through said second hole of said engaging member.

19. The attachment of claim 16, wherein said engaging member has a first upright protrusion of a sufficient height on said left end of said engaging member and a second upright protrusion of a sufficient height on said right end of said engaging member;
wherein said first upright protrusion has a first hole of a sufficient size that is centered within said first upright protrusion and said second upright protrusion has a second hole of a sufficient size that is centered within said second upright protrusion;
wherein said locking member has a right securing hook and a left securing hook;
wherein said right securing hook of said locking member is connected to said engaging member by sliding said right securing hook through said first hole of said engaging member and said left securing hook of said locking member is connected to said engaging member by sliding said left securing hook through said second hole of said engaging member.

20. A method for locking a hinged garbage bin lid closed, then automatically releasing when the garbage bin is raised during automated garbage pickup, comprising:
a preexisting garbage bin and a preexisting garbage bin lid;
wherein said preexisting garbage bin lid has a front end and a back end and said back end of said preexisting garbage bin lid is hingedly connected to a back end of said preexisting garbage bin;
wherein said preexisting garbage bin includes a front protrusion within a front end of said preexisting garbage bin;
an engaging member made of a sturdy material that is securely connected to said front end of said preexisting garbage bin lid;
a locking member made of a sturdy material and of a sufficient shape that is securely connected to said engaging member and will lock said preexisting garbage bin lid in a closed position when said locking member securely engages said front protrusion on said front end of said preexisting garbage bin when said preexisting garbage bin is set upright on a flat surface;
wherein said locking member will automatically disengage and allow said preexisting garbage bin lid to open when said preexisting garbage bin is raised and tilted at an angle;
wherein said locking member comprises a single member with a right half and a left half;
wherein said right half has a first folded angle after a first sufficient length, a second folded angle after a second sufficient length and a third folded angle after a third sufficient length; after a first sufficient length, a second folded angle after a second sufficient length and a third folded angle after a third sufficient length;
wherein said left half has a first folded angle after a first sufficient length, a second folded angle after a second sufficient length and a third folded angle after a third sufficient length; after a first sufficient length, a second folded angle after a second sufficient length and a third folded angle after a third sufficient length;
wherein said first sufficient length, said second sufficient length and said third sufficient length of said right half is approximately one third of the total length of said right half;
wherein said first sufficient length, said second sufficient length and said third sufficient length of said left half is approximately one third of the total length of said left half;
wherein said locking member is securely engaged with said front protrusion on said preexisting garbage bin;
wherein said preexisting garbage bin is standing upright on a flat surface.
